(19) United States
(12) Patent Application Publication
(10) Pub. No.: US 2012/0038624 A1
(43) Pub. Date: Feb. 16, 2012

(54) SYSTEM, METHOD, AND COMPUTER PROGRAM PRODUCT FOR ACTIVATING A BACKLIGHT OF A DISPLAY DEVICE DISPLAYING STEREOSCOPIC DISPLAY CONTENT

(75) Inventor: Gerrit Slavenburg, San Jose, CA (US)

(73) Assignee: NVIDIA CORPORATION, Santa Clara, CA (US)

(21) Appl. No.: 12/854,100

(22) Filed: Aug. 10, 2010

(51) Int. Cl. G06T 15/00; G09G 3/36

(52) U.S. Cl. 345/419; 345/102

(57) ABSTRACT

A system, method, and computer program product are provided for activating a backlight of a display device displaying stereoscopic content. In use, a state of a display device is identified in which an entirety of an image of stereoscopic display content intended for viewing only by a first eye of a user is displayed. Further, a backlight of the display device is activated, in response to the detection of the state.

### FIELD OF THE INVENTION

The present invention relates to video displays, and more particularly to viewing stereo video and graphics images utilizing stereo shutter glasses.

### BACKGROUND

Various display devices are equipped for both mono and stereo viewing. Unlike mono viewing, stereo viewing involves the display of separate content for the right and left human eye. Specifically, such stereo viewing requires the presentation of a separate image to the left and right human eye. In one particular type of stereo viewing, namely time sequential stereo, such left and right images are presented in an alternating manner.

To ensure a proper stereo viewing experience, alternating shutter glasses are also typically used which make the left image visible to the left eye and the right image to the right eye at the appropriate time.

In the past, time sequential stereo viewing has worked well on CRTs and related displays [e.g. high frame rate (DLP) projectors, etc.]. However, time sequential stereo viewing has not shown promise with liquid crystal displays (LCDs), whether flat-panel or in the form of a projector, due to several issues. For example, a slow response time of pixels in LCD environments causes ‘ghosting’ of the left image in the right view, and visa versa. Still yet, the nature of the LCD update process unfortunately results in only short periods of time when the right image and left image may be present in their entirety, as will now be described in more detail.

FIG. 1A illustrates hypothetical shortcomings that would exist if stereo viewing were attempted utilizing an LCD. As shown in the present hypothetical example, the LCD would receive pixels in raster scan order (i.e. left to right, line by line from top to bottom, etc.) over a cable 10, such as a digital video interface (DVI) or video graphics array (VGA) cable. A first left image L1 intended for viewing by a left eye is sent over the cable 10 first. Thereafter, there is a pause in transmission called the vertical blanking interval VBI. Next, a first right image 121 intended for the right eye is sent, and so forth.

Unlike CRTs and other related displays, LCD pixels have individual capacitive storage elements that cause each pixel to retain its color and intensity until it is updated by LCD driver-related electronics, which addresses pixels in raster order. Thus, at time T1, when part of the first right image R1 has been sent, the actual image emitted from the LCD screen includes the ‘not yet overwritten’ part of first left image L1 at the bottom, and the newly written part of the first right image R1. Further, at T2, and, in fact, for the entire vertical blanking interval VBI starting at time T2, the display emits only the first right image R1. At time T3, the first right image 121 has been partially overwritten by a second left image L2, in the manner shown. To this end, if the display content at time TI and T3 were shown to the left or right eye, such eye would unfortunately receive content, at least in part, not intended for such eye.

As mentioned earlier, stereo glasses equipped with right and left eye shutters are often employed to ensure that the proper eye views the appropriate image, during stereo viewing. As shown, in the present hypothetical example, after the first left image L1 is displayed, a left eye shutter control 20 switches the left shutter to an open orientation (during which a right shutter is maintained in a closed orientation). Similarly, after the first right image R1 is displayed, a right eye shutter control 30 switches the right shutter to an open orientation (at which time the left shutter toggles to and is maintained in a closed orientation).

Again, each eye unfortunately, receives content, at least in part, not intended for such eye for a sizeable portion of the duration in which the associated shutter is in the open orientation, resulting in unacceptable stereo viewing. There is thus a need for overcoming these and/or other problems associated with the prior art.

### SUMMARY

A system, method, and computer program product are provided for activating a backlight of a display device displaying stereoscopic content. In use, a state of a display device is identified in which an entirety of an image of stereoscopic display content intended for viewing only by a first eye of a user is displayed. Further, a backlight of the display device is activated, in response to the detection of the state.

### BRIEF DESCRIPTION OF THE DRAWINGS

FIG. 1A illustrates hypothetical shortcomings that would exist if stereo viewing were attempted utilizing a liquid crystal display (LCD).

FIG. 1B illustrates an exemplary computer system in which the various architecture and/or functionality of various embodiments may be implemented.

FIG. 2 shows an exemplary timing for activating a backlight of a display device displaying stereoscopic content, in accordance with one embodiment.

FIG. 3 shows a method for controlling a backlight of a display device during the display of display content to be viewed utilizing stereo glasses, in accordance with another embodiment.

FIG. 4 shows a method for controlling stereo glasses during a display of display content, in accordance with another embodiment.

### DETAILED DESCRIPTION

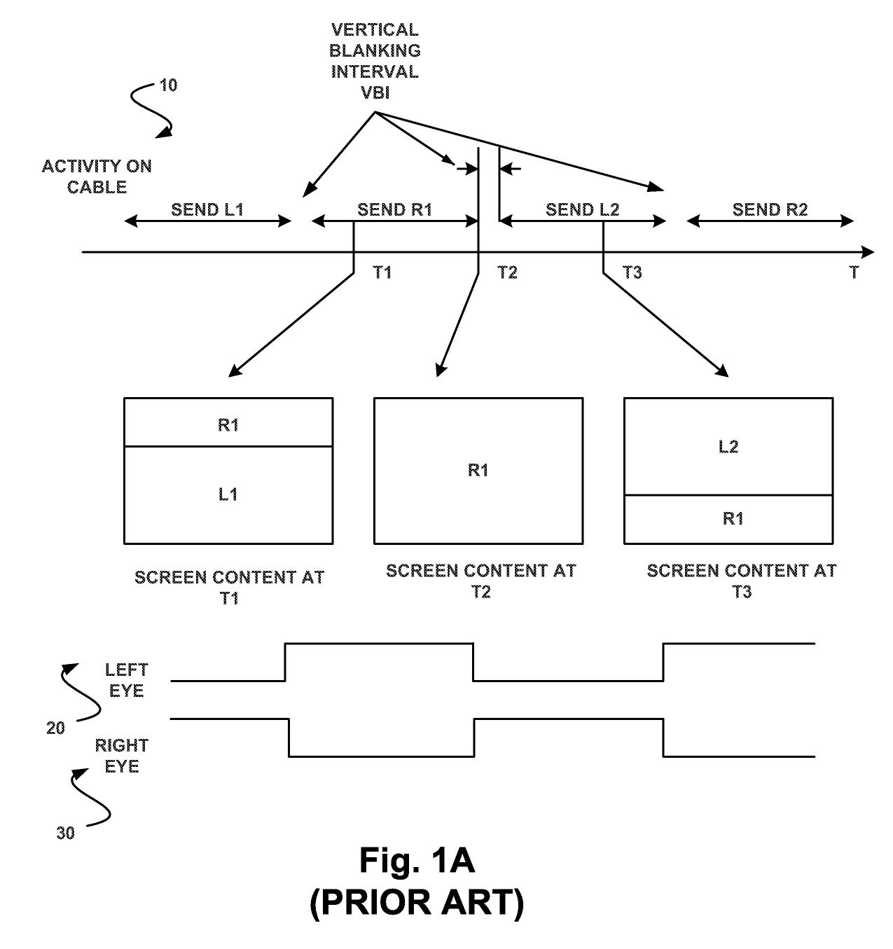

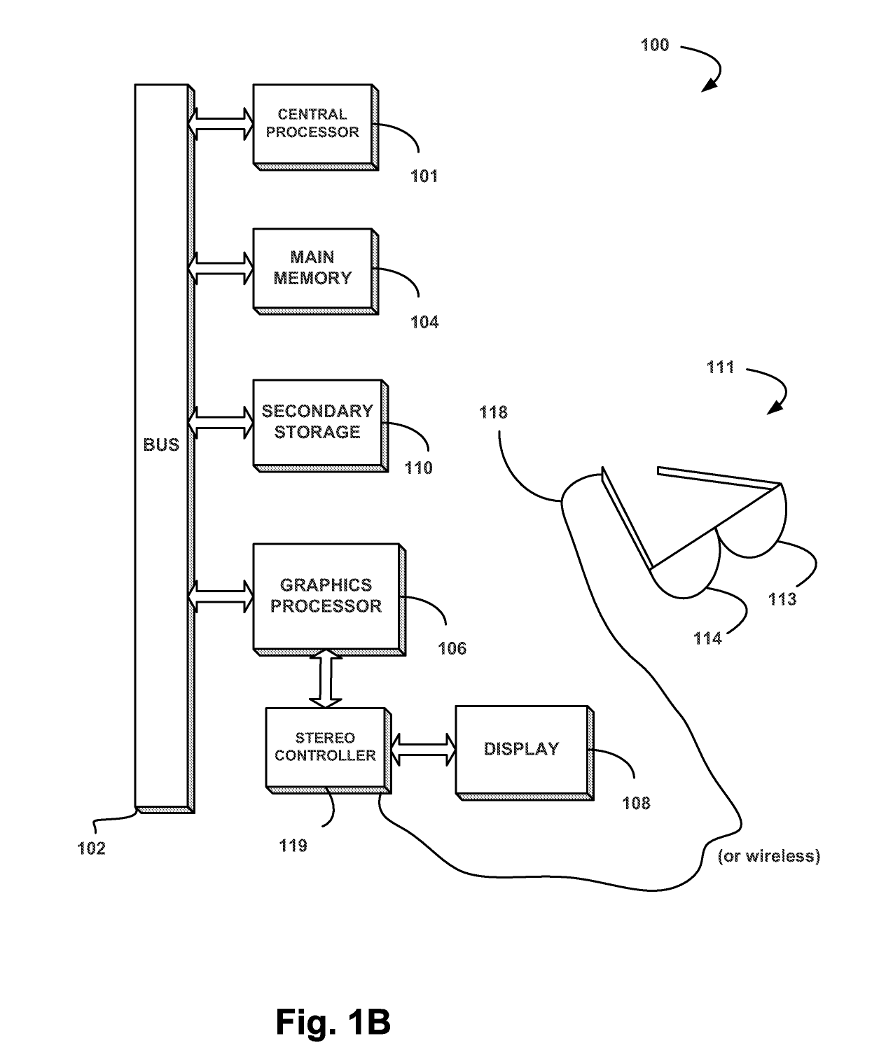

FIG. 1B illustrates an exemplary computer system 100 in which the various architecture and/or functionality of different embodiments may be implemented. As shown, a computer system 100 is provided including at least one host processor 101 which is connected to a communication bus 102. The computer system 100 also includes a main memory 104. Control logic (software) and data are stored in the main memory 104 which may take the form of random access memory (RAM).

The computer system 100 also includes a graphics processor 106 and a display 108 in the form of a liquid crystal display (LCD), digital light processing (DLP) display, liquid crystal on silicon (LCOS) display, plasma display, or other similar display. In one embodiment, the graphics processor 106 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computer system 100 may also include a secondary storage 110. The secondary storage 110 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 104 and/or the secondary storage 110. Such computer programs, when executed, enable the computer system 100 to perform various functions. Memory 104, storage 110 and/or any other storage are possible examples of computer-readable media.

Further included is a pair of stereo glasses 111 capable of being worn on a face of a user. While the stereo glasses 111 are shown to include two elongated members for supporting the same on the face of the user, it should be noted that other constructions (e.g. member-less design, head strap, helmet, etc.) may be used to provide similar or any other type of support. As further shown, the stereo glasses 111 also include a right eye shutter 114 and a left eye shutter 113.

Both the right eye shutter 114 and left eye shutter 113 are capable of both an open orientation and a closed orientation. In use, the open orientation allows more light therethrough with respect to the closed orientation. Of course, such orientations may be achieved by any desired mechanical, electrical, optical, and/or any other mechanism capable of carrying out the above functionality.

For control purposes, the stereo glasses 111 may be coupled to a stereo controller 119 via a cable 118 (or without the cable 118 in a wireless environment). The stereo controller 119 is, in turn, coupled between the graphics processor 106 and the display 108 for carrying out the functionality to be set forth hereinafter. While the stereo controller 119 is shown to reside between the graphics processor 106 and the display 108, it should be noted that the stereo controller 119 may reside in any location associated with the computer system 100, the stereo glasses 111, and/or even in a separate module, particularly (but not necessarily) in an embodiment where the graphics processor 106 is attached to a separate interface [e.g. universal serial bus (USB), etc.] on the computer system 100. In one embodiment, the display 108 may be directly connected to the computer system 100, and the stereo controller 119 may further be directly connected to the computer system 100 via a USB interface. Still yet, the stereo controller 119 may comprise any hardware and/or software capable of the providing the desired functionality.

In some embodiments, the right eye shutter 114 and left eye shutter 113 may be controlled to switch between the closed orientation and the open orientation. Various examples of such control are described in further detail in U.S. Pat. No. 7,724,211, issued May 25, 2010 and U.S. patent application Ser. No. 11/462,535, filed Aug. 4, 2006, both of which are incorporated herein by reference in their entirety.

In other embodiments, a backlight of the display 108 may be controlled to switch between an activated orientation and a deactivated orientation, whereby the backlight is powered on in the activated orientation and is powered off in the deactivated orientation. Specifically, as described below, the backlight of the display 108 may be activated in response to detection of a state of the display 108 in which an entirety of an image of stereoscopic display content intended for viewing only by a first eye of the user is displayed. In particular, as will soon become apparent, such technique may reduce power consumption of the display 108, while optionally simplifying functionality of the stereo glasses 111.

More illustrative information will now be set forth regarding various optional architectures and features with which the foregoing functionality may or may not be implemented, per the desires of the user. It should be strongly noted that the following information is set forth for illustrative purposes and should not be construed as limiting in any manner. Any of the following features may be optionally incorporated with or without the exclusion of other features described.

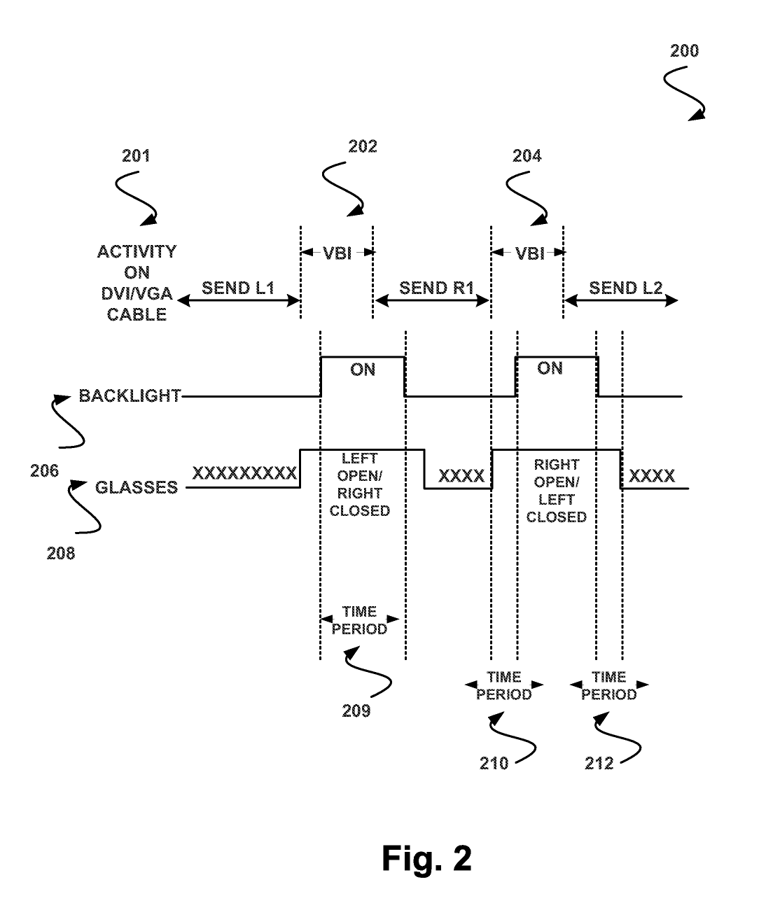

FIG. 2 shows an exemplary timing 200 for activating a backlight of a display device displaying stereoscopic content, in accordance with one embodiment. As an option, the present timing 200 may be implemented in the context of the computer system 100 of FIG. 1B. Of course, however, the timing 200 may be used in any desired environment. Still yet, the above definitions apply during the following description.

As shown, a display (e.g. display 108 of FIG. 1, etc.) receives stereoscopic display content over a communication medium 201, such as a digital video interface (DVI) or video graphics array (VGA) cable, or any other medium capable of communicating the display content, for that matter. In the context of the present description, such stereoscopic display content may include pixel-related information, image(s), and/or any other content or component thereof at any stage of processing capable of being displayed for stereoscopic viewing. In FIG. 2, a first left image L1 intended for viewing only by a left eye is shown to be sent over the communication medium 201 first. Thereafter, there is a pause in transmission, namely the vertical blanking interval VBI. Next, a first right image R1 intended for only the right eye is then sent, and so forth. As shown, a first set of vertical blanking intervals 202 alternate with a second set of vertical blanking intervals 204, and they both occur between periods during which right eye content or left eye content is received from a content source.

As further shown, a backlight of the display is controlled to switch between an activated orientation and a deactivated orientation. In one embodiment, this may be accomplished utilizing a backlight control signal 206 for controlling the backlight.

Specifically, the backlight is activated in response to detection of a state of the display in which an entirety of an image of the stereoscopic display content intended for viewing only by a first eye of the user is displayed. As shown, the backlight may be controlled such that the backlight is activated (e.g. from a deactivated orientation) in response to receipt of an entirety of the first left image L1. Thus, the backlight may be activated in response to detection of a state of the display in which an entirety of the first left image L1 has been received and is accordingly being displayed by the display.

Further, the backlight may remain activated at least for a duration of the first set of vertical blanking intervals 202, which follow the receipt of the entirety of the first left image L1. For example, the backlight may remain activated at least during the display of the entirety of the first left image L1. Upon completion of the first set of vertical blanking intervals 202, the backlight may again be controlled such that the backlight is deactivated (e.g. from the activated orientation described above).

In a similar manner, the backlight may be controlled such that the backlight is activated (e.g. from a deactivated orientation) in response to receipt of an entirety of the first right image R1. In this way, the backlight may be activated in response to detection of a state of the display in which an entirety of the first right image R1 has been received and is accordingly being displayed by the display.

Further, the backlight may remain activated at least for a duration of the second set of vertical blanking intervals 204, which follow the receipt of the entirety of the first right image R1. For example, the backlight may remain activated at least during the display of the entirety of the first right image R1. Upon completion of the second set of vertical blanking intervals 204, the backlight may again be controlled such that the backlight is deactivated (e.g. from the activated orientation described above).

As also shown, and strictly as an option, the backlight may be activated in the manner described above a first predetermined amount of time after the detection that the display is in a state in which an entirety of the first left image L1/first right image R1 has been received for display. Further, as shown, and strictly as another option, the backlight may remain activated in the manner described above for a second predetermined amount of time after the duration of the first set of vertical blanking intervals 202/second set of vertical blanking intervals 204. It should be noted that the first predetermined amount of time and the second predetermined amount of time may be the same or different in length.

Such first predetermined amount of time may provide a delay prior to activation of the backlight, for allowing the display to transition between receipt of the first left image L1/first right image R1 and the actual display thereof. Similarly, the second predetermined amount of time may provide a delay prior to deactivation of the backlight, for allowing the backlight to remain activated during a transition between receipt of a subsequent image for display and the actual start of the display thereof. In this way, the backlight may remain activated for a time period 209 beginning after the start of the first set of vertical blanking intervals 202/second set of vertical blanking intervals 204 and ending after the termination of the first set of vertical blanking intervals 202/second set of vertical blanking intervals 204.

To this end, the backlight may optionally only be activated when the display is displaying only a single image intended for viewing by a single eye of the user. By deactivating the backlight when a combination of a left eye image and a right eye image are being displayed (e.g. when the first left image L1 has been partially overwritten by the first right image R1, and so on), the user may be prevented from viewing the same regardless of the orientation of the stereo glasses 111 being worn. For example, the right eye content may be prevented from reaching the left eye and the left eye content may be prevented from reaching the right eye. Furthermore, deactivating the backlight in this manner may reduce power consumption of the display (e.g. as opposed to a situation where the backlight of the display is always activated), may allow brightness of the display to be increased while maintaining a same average power (e.g. as that where the backlight of the display is always activated), or may allow a combination of the aforementioned reduction in power consumption and the increased brightness.

Moreover, as shown, a right eye shutter and left eye shutter of the stereo glasses (e.g. stereo glasses 111, etc.) are controlled independently. In one embodiment, this may be accomplished utilizing a stereo glasses signal 208. Of course, as another option, a right eye control signal may be used for controlling the right eye shutter and a left control signal may be used for controlling the left eye shutter.

Specifically, the left eye shutter of the stereo glasses may be controlled such that the left eye shutter is in an open orientation at least for the duration that the backlight is activated with respect to the display of the first left image L1. Further, the right eye shutter of the stereo glasses may be controlled such that the right eye shutter is in a closed orientation at least for the duration that the backlight is activated with respect to the display of the first left image L1. Similarly, the left eye shutter of the stereo glasses may be controlled such that the left eye shutter is in a closed orientation at least for the duration that the backlight is activated with respect to the display of the first right image R1, and the right eye shutter of the stereo glasses may be controlled such that the right eye shutter is in an open orientation at least for the duration that the backlight is activated with respect to the display of the first right image R1.

To this end, the left eye shutter and the right eye shutter may optionally only be controlled between a first state of the stereo glasses 111 and a second state of the stereo glasses 111. Namely, the first state may include the left eye shutter being in the open orientation and the right eye shutter being in the closed orientation, and the second state may include the left eye shutter being in the closed orientation and the right eye shutter being in the open orientation. For example, upon deactivation of the backlight following the first set of vertical blanking intervals 202, the orientation of the left eye shutter and the right eye shutter may be maintained in the first state until the backlight is activated following the second set of vertical blanking intervals 204, at which time the orientation of the left eye shutter and the right eye shutter may be switched to the second state, and so forth.

In another embodiment, the left eye shutter and the right eye shutter may be controlled such that the left eye shutter and the right eye shutter are simultaneously in the open orientation while the backlight is deactivated. For example, upon deactivation of the backlight (e.g. following the first set of vertical blanking intervals 202, etc.), the left eye shutter and the right eye shutter may be controlled such that the left eye shutter and the right eye shutter are both in the open orientation. In yet another embodiment, the left eye shutter and the right eye shutter may be controlled such that the left eye shutter and the right eye shutter are simultaneously in the closed orientation while the backlight is deactivated. For example, upon deactivation of the backlight (e.g. following the first set of vertical blanking intervals 202, etc.), the left eye shutter and the right eye shutter may be controlled such that the left eye shutter and the right eye shutter are both in the closed orientation.

As a further option, the left eye shutter and the right eye shutter may be controlled such that the left eye shutter and the right eye shutter are oriented in the aforementioned first state for a duration of time longer than that in which the backlight is activated with respect to the display of the first left image L1. For example, the left eye shutter and the right eye shutter may be oriented into the first state (e.g. from the second state) prior to activation of the backlight with respect to the display of the first left image L1. See time period 210, for example. This may occur, for example, where there is a delay between instructing the left eye shutter/right eye shutter to change orientation and completion of the actual change in orientation (e.g. where the change in orientation is slow).

As another example, the left eye shutter and the right eye shutter may remain oriented in the first state after deactivation of the backlight with respect to the display of the first left image L1 (e.g. to accommodate any delay in changing the orientation from the first state to a simultaneous closed orientation, etc.). See time period 212, for example. For similar reasons to those noted above, the left eye shutter and the right eye shutter may be controlled such that the left eye shutter and the right eye shutter are oriented in the aforementioned second state for a duration of time longer than that in which the backlight is activated with respect to the display of the first right image R1.

To this end, the backlight may be deactivated as described above, such that the stereo glasses 111 may be allowed to only operate between two states or to transition between various other states with delay, while ensuring enhanced viewing of stereoscopic display content (e.g. via the prevention of the user viewing a combination of a left eye image and a right eye image being displayed). This technique may therefore simplify functionality of the stereo glasses 111.

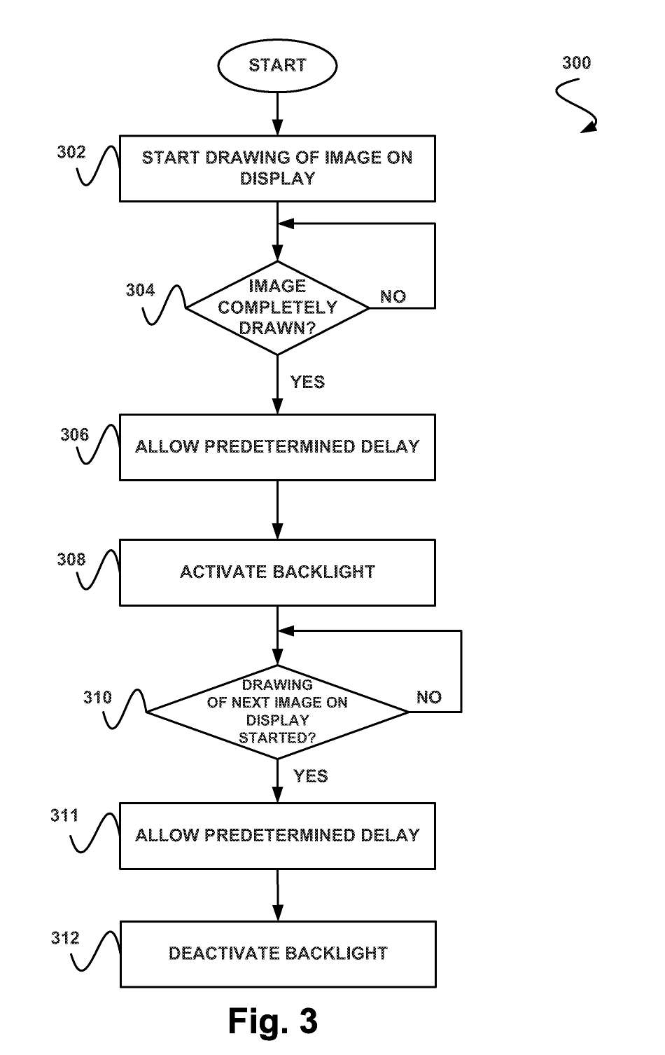

FIG. 3 shows a method 300 for controlling a backlight of a display device during the display of display content to be viewed utilizing stereo glasses, in accordance with another embodiment. As an option, the present method 300 may be carried out in the context of the computer system 100 of FIG. 1B and/or the timing 200 of FIG. 2. Of course, however, the method 300 may be implemented in any desired environment. Again, the definitions introduced hereinabove apply during the following description.

As shown in operation 302, drawing of an image on a display is started. With respect to the present embodiment, drawing the image on the display may include updating each scan line of the display to display an associated portion of the image. Thus, for a display whose scan lines are refreshed from top to bottom, the image may be started to be drawn on the display by drawing a top scan line of the display.

Also with respect to the present embodiment, the image is one which is intended for viewing only by a particular eye of a user via stereo glasses worn by the user. For example, the image may include a left eye image or a right eye image.

It is then determined whether the image has been completely drawn, as shown in decision 304. In particular, it is determined whether the display is in a state in which an entirety of the image is being displayed. In one embodiment, the state may be detected in response to a last scan line of the display being updated to display an associated portion of the image. To this end, the state may include a completed transition of the display to the display of the image intended for viewing by the particular eye of the user from a display of another image intended for viewing by the other eye of the user.

If it is determined that the image has not been completely drawn, the method 300 continues to wait for it to be determined that the image has been completely drawn. Once it is determined that the image has been completely drawn, a predetermined delay is allowed. Note operation 306. For example, the predetermined delay may allow for the display to enter a state in which the entire image is being displayed (e.g. from a state in which the entire image has been received by the display).

Further, the backlight is activated, as shown in operation 308. In particular, the backlight may be activated from a deactivated orientation. For example, the backlight may be powered on from a powered off orientation. Once the backlight is activated, the user may be capable of viewing the image (e.g. via stereo glasses worn by the user).

Still yet, as shown in decision 310, it is determined whether a next image has started to be drawn on the display. If it is determined that drawing of the next image on the display has not been started, the backlight remains activated. However, upon a determination that drawing of the next image on the display has been started, a predetermined delay is allowed. Note operation 311. Such predetermined delay may include a predetermined amount of time which allows for a delay of the display in receiving the next image for display and actually beginning display of such next image.

Furthermore, the backlight is deactivated. Note operation 312. Accordingly, the backlight may remain activated until the image begins to be overwritten on the display. For example, the backlight may be deactivated during a transition of the display from the display of the image intended for viewing by the particular eye of the user to a display of another image intended for viewing by the other eye of the user. Specifically, the backlight may be deactivated in response to detection of such transition. Moreover, as noted above, the backlight may be deactivated the predetermined amount of time after the detection of the transition. Such deactivation may prevent the user from viewing on the display a combination of the image and the next image being displayed (e.g. where the next image has started overwriting the already displayed image).

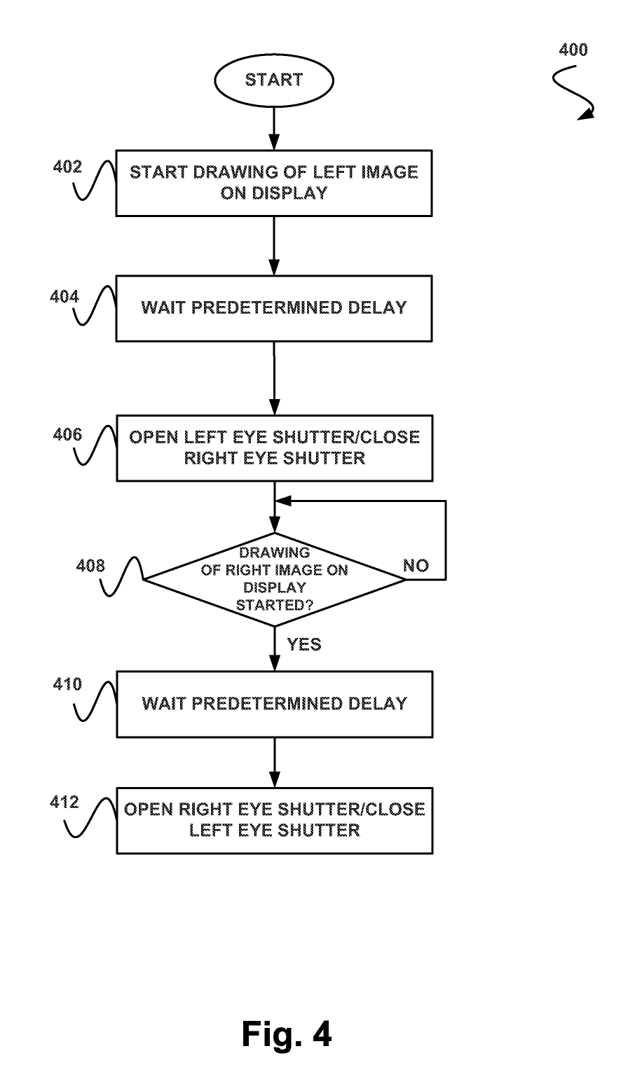

FIG. 4 shows a method 400 for controlling stereo glasses during a display of display content, in accordance with another embodiment. As an option, the present method 400 may be carried out in the context of the computer system 100 of FIG. 1B and/or the timing 200 of FIG. 2. Of course, however, the method 400 may be implemented in any desired environment. Again, the definitions introduced hereinabove apply during the following description.

As shown in operation 402, drawing of a left image on a display is started. With respect to the present embodiment, drawing the left image on the display may include updating each scan line of the display to display an associated portion of the left image. Also with respect to the present embodiment, the left image is one which is intended for viewing only by a left eye of a user via stereo glasses worn by the user.

A predetermined delay is then allowed to pass, as shown in operation 404. The predetermined delay may include any amount of time that is pre-configured. In this way, such pre-configured amount of time may be allowed to pass (e.g. without necessarily controlling the stereo glasses during such time).

After the predetermined delay passes, a left eye shutter of the stereo glasses is opened and a right eye shutter of the stereo glasses is closed. Note operation 406. Thus, the stereo glasses may be controlled such that the left image is only viewed by the left eye of the user. Since opening/closing of the shutters may take time (e.g. may not necessarily be instantaneous), the stereo glasses may be controlled to open the left eye shutter of the stereo glasses and close the right eye shutter of the stereo glasses while the left image is being drawn to the display. To compensate for a situation where the left eye shutter of the stereo glasses is opened prior to the entirety of the left image being displayed (e.g. where the left image is still overwriting a right image), the backlight may be in a deactivated state until the left image is completely drawn (as described above with respect to FIG. 3). Thus, the stereo glasses may be provided with an entire time that the backlight is off to switch to the state where the left eye shutter of the stereo glasses is opened and the right eye shutter of the stereo glasses is closed.

Further, as shown in decision 408, it is determined whether drawing of a right image on the display has been started. For example, it may be determined whether the left image has begun to be overwritten by the right image. If it is determined that drawing of the right image on the display has not been started, the method 400 continues to wait for such right image to be begun to be drawn on the display.

However, upon a determination that drawing of the right image on the display has been started, the predetermined delay is allowed to pass. Note operation 410. As similarly noted above, the pre-configured amount of time provided by the predetermined delay may be allowed to pass (e.g. without necessarily controlling the stereo glasses during such time).

After the predetermined delay, the right eye shutter of the stereo glasses is opened and the left eye shutter of the stereo glasses is closed. Note operation 412. Thus, the stereo glasses may be controlled such that the right image is only viewed by the right eye of the user. Again, since opening/closing of the shutters may take time (e.g. may not necessarily be instantaneous), the stereo glasses may be controlled to open the right eye shutter of the stereo glasses and close the left eye shutter of the stereo glasses while the right image is being drawn to the display. To compensate for a situation where the right eye shutter of the stereo glasses is opened prior to the entirety of the right image being displayed (e.g. where the right image is still overwriting a left image), the backlight may be in a deactivated state until the right image is completely drawn (as described above with respect to FIG. 3). Thus, the stereo glasses may be provided with an entire time that the backlight is off to switch to the state where the right eye shutter of the stereo glasses is opened and the left eye shutter of the stereo glasses is closed.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
detecting a state of a display device in which an entirety of an image of stereoscopic display content intended for viewing only by a first eye of a user is displayed; and
activating a backlight of the display device, in response to the detection of the state.

2. The method of claim 1, wherein the display device includes a liquid crystal display (LCD).

3. The method of claim 1, wherein the state is detected in response to a last scan line of the display device being updated to display an associated portion of the image.

4. The method of claim 1, wherein the state includes a completed transition of the display device from a display of another image intended for viewing by only a second eye of the user to the display of the image intended for viewing by only the first eye of the user.

5. The method of claim 1, wherein the backlight is activated from a deactivated orientation.

6. The method of claim 1, further comprising maintaining activation of the backlight during the display of the entirety of the image intended for viewing only by the first eye of the user.

7. The method of claim 1, wherein the backlight is activated a predetermined amount of time after the detection.

8. The method of claim 1, wherein the backlight is deactivated during a transition of the display device from the display of the image intended for viewing only by the first eye of the user to a display of another image intended for viewing only by a second eye of the user.

9. The method of claim 8, wherein in response to detection of the transition, the backlight is deactivated.

10. The method of claim 9, wherein the backlight is deactivated a predetermined amount of time after the detection of the transition.

11. The method of claim 9, wherein the backlight is deactivated in response to the detection of the transition such that the user is prevented from viewing on the display device a combination of the image intended for viewing only by the first eye of the user and the other image intended for viewing only by a second eye of the user.

12. The method of claim 1, further comprising controlling a first eye shutter and a second eye shutter of stereo glasses.

13. The method of claim 12, wherein the first eye shutter and the second eye shutter of the stereo glasses are controlled such that the first eye shutter is in an open orientation during the display of the entirety of the image intended for viewing only by the first eye of the user and the second eye shutter is in a closed orientation during the display of the entirety of the image intended for viewing only by the first eye of the user.

14. The method of claim 12, wherein the first eye shutter and the second eye shutter of the stereo glasses are controlled such that the first eye shutter is in a closed orientation during a display of an entirety of an image intended for viewing only by a second eye of the user and the second eye shutter is in an open orientation during the display of the entirety of the image intended for viewing only by the second eye of the user.

15. The method of claim 12, wherein the first eye shutter and the second eye shutter of the stereo glasses are controlled such that the first eye shutter and second eye shutter are simultaneously in an open orientation during at least a portion of a transition of the display device from the display of the image intended for viewing only by the first eye of the user to a display of another image intended for viewing only by a second eye of the user.

16. The method of claim 12, wherein the first eye shutter and the second eye shutter of the stereo glasses are controlled such that the first eye shutter and second eye shutter are simultaneously in a closed orientation during at least a portion of a transition of the display device from the display of the image intended for viewing only by the first eye of the user to a display of another image intended for viewing only by a second eye of the user.

17. The method of claim 12, wherein the first eye shutter and the second eye shutter of the stereo glasses are only controlled between a first state of the stereo glasses and a second state of the stereo glasses, the first state including the first eye shutter being in a closed orientation and the second eye shutter being in an open orientation, and the second state including the first eye shutter being in the open orientation and the second eye shutter being in the closed orientation.

18. A computer program product embodied on a computer readable medium, comprising:
computer code for detecting a state of a display device in which an entirety of an image of stereoscopic display content intended for viewing only by a first eye of a user is displayed; and
computer code for activating a backlight of the display device, in response to the detection of the state.

19. An apparatus, comprising:
a display device for displaying an image of stereoscopic display content intended for viewing only by a first eye of a user; and
a controller for activating a backlight of the display device in response to a detection of a state of the display device in which an entirety of the image intended for viewing by the first eye of the user is displayed.

20. The apparatus of claim 19, wherein the processor remains in communication with memory via a bus.
